(19) United States
(12) Patent Application Publication
(10) Pub. No.: US 2026/0320647 A1
(43) Pub. Date: Oct. 15, 2026

(54) KALMAN FILTER CONTROL FOR PACED DELIVERY OF CONTENT

(71) Applicant: Roku, Inc., San Jose, CA (US)

(72) Inventor: Jorgen Harmse, Austin, TX (US)

(73) Assignee: Roku, Inc., San Jose, CA (US)

(21) Appl. No.: 19/175,462

(22) Filed: Apr. 10, 2025

(51) Int. Cl. G06Q 30/0242; G06Q 30/0273

(52) U.S. Cl. CPC G06Q 30/0244; G06Q 30/0275

(57) ABSTRACT

Kalman filters are used to control paced content delivery, in which a content delivery platform delivers content to a specific subset of end users. A content provider can arrange with the platform to deliver content to a portion of the platform's users. The content provider may specify certain criteria or objectives for the content delivery strategy, e.g., targeting criteria, engagement, or reach. Kalman filters may be used to control the content delivery strategy. For example, a first control knob controlled by a first Kalman filter may be tied to pace, and a second control knob controlled by a second Kalman filter may be tied to a performance objective.

### TECHNICAL FIELD

This disclosure relates generally to content delivery, and more specifically, to pacing delivery of content to users.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 depicts a block diagram of a system environment for paced content delivery, according to some embodiments of the disclosure.

FIG. 2 depicts a block diagram of a server for delivering supplemental content, according to some embodiments of the disclosure.

FIG. 3 depicts a block diagram of a content placement manager in the server of FIG. 2, according to some embodiments of the disclosure.

FIG. 4 depicts a flow diagram illustrating exemplary operations for conducting a content placement campaign, according to some embodiments of the disclosure.

FIG. 5 depicts a flow diagram illustrating exemplary operations for setting control knobs for the content placement campaign, according to some embodiment of the disclosure.

FIG. 6 depicts a flow diagram illustrating exemplary operations for selecting a bid value based on the control knobs, according to some embodiments of the disclosure.

FIG. 7 depicts a flow diagram illustrating exemplary operations for calculating a decoupling value for the control knobs, according to some embodiments of the disclosure.

FIG. 8 depicts a block diagram of an exemplary computing device, according to some embodiments of the disclosure.

### DETAILED DESCRIPTION

### Overview

Kalman filters can be used in systems control to estimate and predict the state of a dynamic system while accounting for noisy measurements and system uncertainties. A Kalman filter operates in two phases: a prediction phase and a correction phase. In the prediction phase, the filter uses a model of the system to estimate the next state. In the correction phase, the filter updates this estimate based on new measurements, weighing the prediction and measurements according to their respective uncertainties. By iterating between these steps, the Kalman filter continuously refines its estimates, providing more accurate control signals for systems such as robotics, navigation, or process control, even in the presence of noise or incomplete information.

A Kalman filter can be applied to control a knob in a process that involves continuous adjustments based on uncertain or noisy measurements. For example, a Kalman filter can be used to set a control knob for a process by continuously estimating the optimal setting of the knob based on noisy measurements and the dynamics of the system. Initially, the Kalman filter makes a prediction about the knob's setting based on previous states and a model of the system. As new data is obtained, the filter updates its estimate of the knob's optimal value by weighing the prediction against the noisy measurement, adjusting for uncertainty in both. This iterative process ensures that the control knob is set accurately over time, even in the presence of measurement errors or system disturbances, providing more precise control in various applications such as temperature regulation, motor speed control, or any system requiring fine-tuned adjustments.

This disclosure concerns the use of Kalman filters in situations where the sensitivity of the system to the knob setting is not known a priori. As described herein, in some applications, Kalman filters are used to control paced content delivery, in which content is delivered to subsets of end users on a content delivery platform. When implementing a content delivery strategy, a content provider can arrange with a platform to deliver content to a portion of the platform's users. The content provider may specify certain criteria or objectives for the content delivery strategy, e.g., targeting criteria, engagement, reach, etc. The content provider has another set of objectives, e.g., delivering quality impressions while achieving adequate margins. Within the content delivery platform, other content providers may compete against the content delivery strategy for the same impressions, e.g., competition to deliver content at a particular time and to a particular user.

To determine which content to provide to a particular user in a given instance (referred to as a content placement or impression), the content delivery platform may implement a bidding system in which different content providers offer different values for the content placement. In a bidding environment, the content provider that offers the highest value may obtain the content placement. In some cases, the content delivery platform may also use other factors, such as relevance of the content, quality of the content, and targeting efficiency, to determine which content provider (and ultimately which content) to select for the content placement. In other words, the selection of content for a content placement may be based on the bid values along with one or more other factors.

It can be challenging to set a bid value for a content delivery strategy. A content provider may offer a fixed price for a set of impressions, e.g., a fixed cost per thousand (CPM), or the content provider may opt for more dynamic pricing throughout a campaign. Within a given campaign, or within a set of impressions (e.g., 1000 impressions), the bid value may change for individual opportunities. Dynamically setting the bid value can help control the pace of delivery, e.g., prevent an expected number of impressions from being delivered too quickly or too slowly. Moreover, dynamically setting the bid value as described herein can meet additional objectives of the content delivery platform and/or content provider, e.g., increase return on the advertising spend, increase profits, and generally increase the return or yield of the campaign.

As described herein, a Kalman filter may be used to control the pacing of a content delivery strategy. For example, a control knob used in setting the bid value may be tied to the pace of the content delivery strategy. In some embodiments, a Kalman filter is used to estimate pace at the current knob value and to estimate sensitivity of the pace to the knob. The estimated pace and sensitivity may then be used to determine an adjustment to the control knob, which in turn adjusts future bid values.

Control knobs based on Kalman filters may be used to control different aspects of a content delivery strategy. For example, Kalman filters may be used to control different objectives, such as pace, cost per acquisition, margin, return on spending, reach, etc. In some embodiments, multiple control knobs based on multiple Kalman filters may be used together.

For example, a first control knob may control pacing, while a second control knob is related to a performance objective, such as reach (e.g., unique users who receive the content), conversions (e.g., users who take a particular action in response to the content), or other objectives related to quality or success of the content delivery strategy. In some embodiments, two or more objectives may be amenable to control by the same knob, and then the number of Kalman filters may exceed the number of knobs. For example, for a target cost per acquisition (CPA) objective, the spend is conceptually unlimited as long as the CPA does not exceed the target, but in practice there is a budget limit; the budget limit prevents unlimited spending until the CPA target is reached.

It can be challenging to use two or more control knobs in a single system if the control knobs or their objectives are related. Making adjustments to a first knob can confuse another Kalman filter that is used to control a second knob, or it may impede movement of the second knob towards its objective. For example, achieving one objective (e.g., precise pacing) may be detrimental towards achieving a different objective (e.g., balancing profit of the demand-side platform (DSP) against return on ad spend). While a single control knob may function to balance two competing objectives, if three or more objectives exist (e.g., pace, margin, and performance), a single control knob can no longer manage the additional objectives. As described herein, multiple control knobs are used to control the trade-off between multiple competing objectives. However, because two or more of the objectives may be tied or related, the control system described herein performs a de-coupling of the Kalman filter outputs prior to setting control knob values. In specific embodiments, the content delivery strategy decouples the values provided by the Kalman filters when setting bid values based on the Kalman filter control knobs.

### Exemplary System Environment for Paced Content Delivery

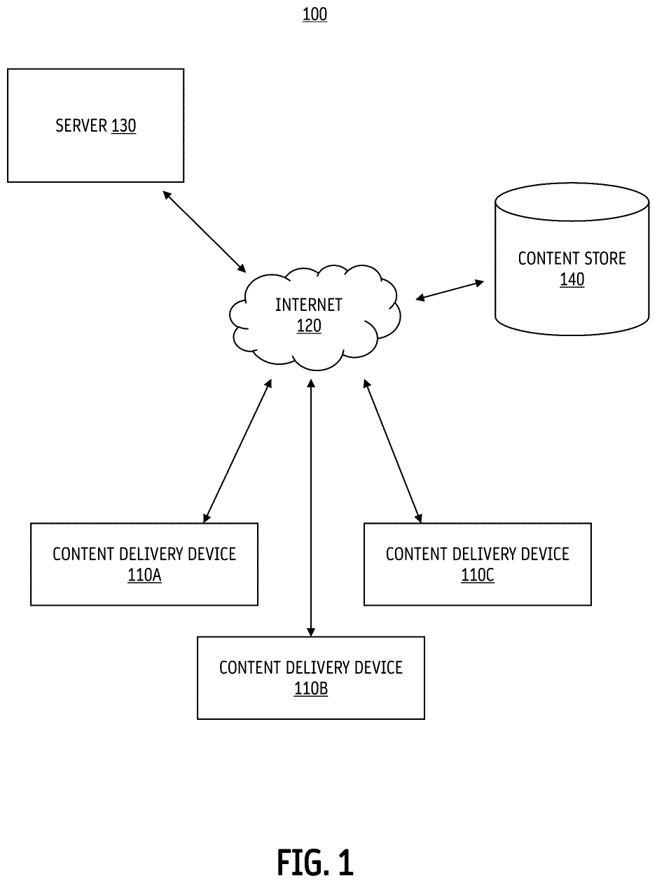

FIG. 1 depicts a block diagram of a system environment 100 for paced content delivery, according to some embodiments of the disclosure. FIG. 1 includes a set of content delivery devices 110A, 110B, and 110C, jointly referred to as content delivery devices 110 or singularly as content delivery device 110. FIG. 1 further includes Internet 120, server 130, and content store 140. Each of content delivery devices 110, as well as server 130 and content store 140, provides a connection to the Internet 120, so that content delivery devices 110, server 130, and content store 140 may communicate.

A content delivery device 110 may include hardware and software. Hardware can include physical components of the content delivery device 110. For example, hardware may include a processor, a memory, a network adapter, other communication devices, cryptography accelerator, decoder, light-emitting device, sensors, input device, output device, media card reader, identity module, etc. Software can include instructions, data, and/or programs that can be executed by the processor to perform one or more tasks and/or to manipulate one or more components in the hardware. Software can include an operating system and one or more applications. In some embodiments, a content delivery device 110 is a streaming device for streaming content, such as video content and/or audio content. In some embodiments, one or more of the content delivery devices 110 may be a small form factor device, such as a dongle or a stick. In some embodiments, one or more of the content delivery devices 110 may be a box that can be connected to a display. In some embodiments, one or more of the content delivery devices 110 may be a display device that includes built-in streaming functionality.

Server 130 may be related to one or more of content delivery devices 110. For example, server 130 may provide data to one or more of content delivery devices 110 and/or receive data from one or more of content delivery devices 110. Server 130 may control content delivery to content delivery devices 110, e.g., server 130 may operate a content delivery platform accessed by content delivery devices 110. For example, server 130 may provide or enable a user interface on a content delivery device 110 through which a user may request content (e.g., streaming media content) via the Internet 120. Server 130 may return the requested content to the requesting content delivery device 110. In some embodiments, content may be stored on content store 140, and server 130 instructs content store 140 to transmit content to content delivery device 110.

In some embodiments, server 130 stores content received from a content provider on content store 140. In some embodiments, a content provider makes content stored on content store 140 available to users of server 130; the content provider may instruct server 130 to direct content delivery devices 110 to content store 140 to obtain content, for example. In such cases, the content itself may not pass through server 130.

In some embodiments, server 130 provides paced delivery of content to users through content delivery devices 110. For example, a content provider may request a service associated with server 130 (e.g., the content delivery platform) to deliver content to users of the content delivery platform. Such content may be supplemental content delivered in addition to or in coordination with content specifically requested by a user of a content delivery device 110. For example, supplemental content subject to paced delivery may include various on-screen supplemental content, such as banner advertisements, interstitial advertisements, streamed content such as pre-roll advertisements, mid-roll advertisements, post-role advertisements, bumper advertisements, or other types of sponsored content. The supplemental content may be stored on content store 140 and, if the content delivery platform selects a particular content item for delivery to a particular content delivery device 110, server 130 may retrieve the content item from content store 140 and transmit it to content delivery device 110. Alternatively, server 130 may direct content store 140 to transmit the particular content item to content delivery device 110, or server 130 may instruct content delivery device 110 to retrieve the particular content item from content store 140.

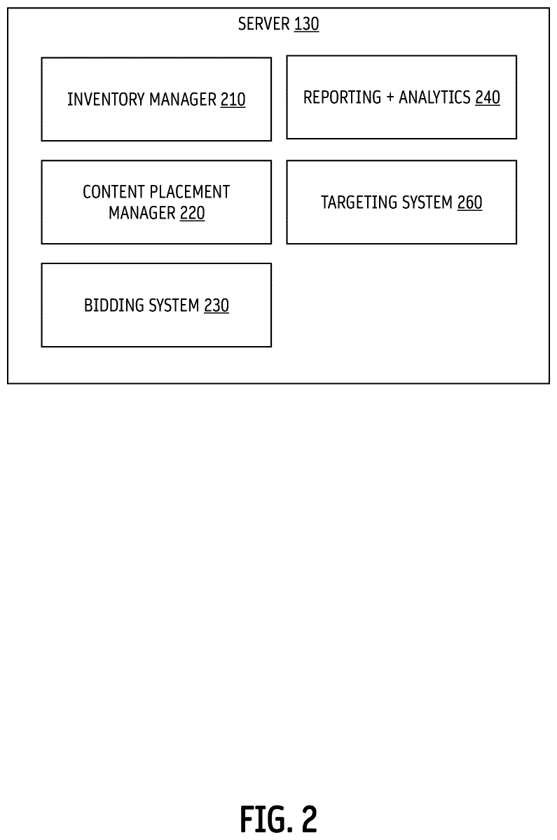

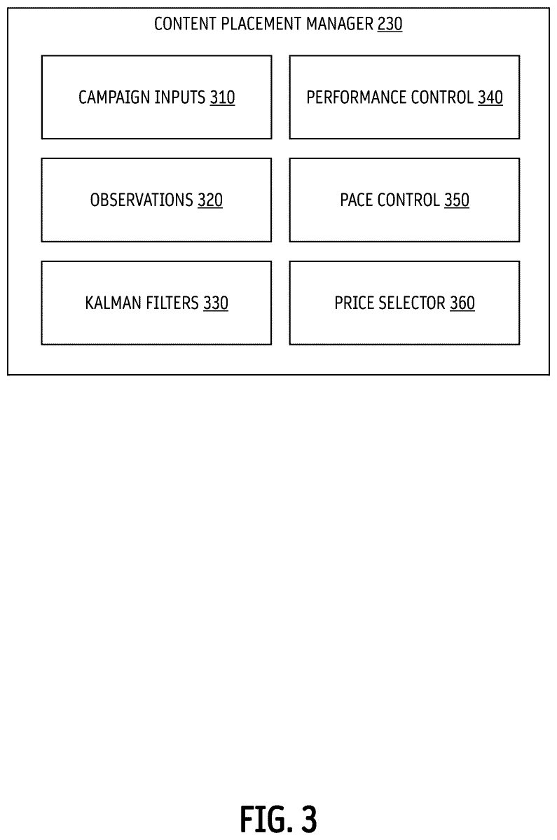

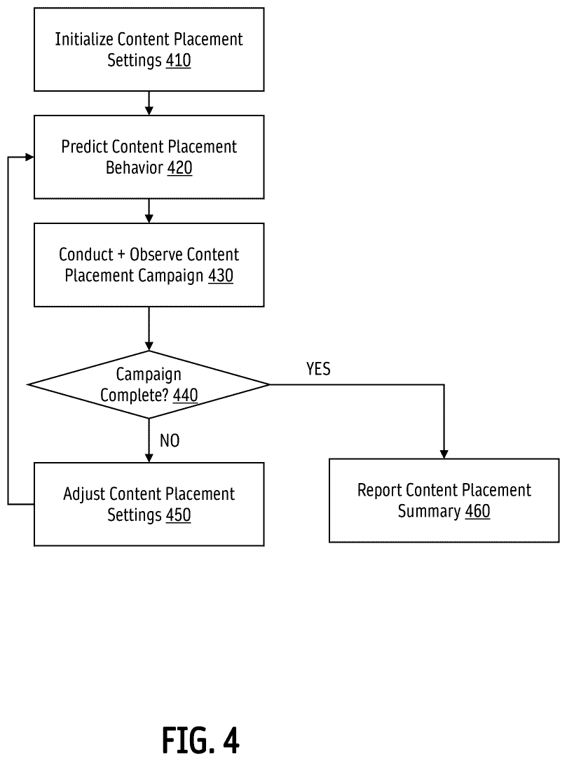

Several components of server 130 related to delivery of supplemental content are shown in FIGS. 2 and 3 and described below, and processes that may be performed by server 130 are shown in FIGS. 4-7 and described further below.

### Exemplary Server for Delivering Supplemental Content

FIG. 2 depicts a block diagram of server 130 for delivering supplemental content, according to some embodiments of the disclosure. Server 130 may represent a group of related servers and/or other computing devices, e.g., devices in a cloud computing environment that can implement functionality of server 130 described herein. Server 130 includes inventory manager 210, content placement manager 220, bidding system 230, reporting and analytics 240, and targeting system 250. While the aspects described below relate primarily to supplemental content, server 130 may also deliver other types of content (e.g., user-requested content); alternatively, this may be handled by a separate server.

Inventory manager 210 manages inventory of supplemental content managed by the content delivery platform implemented by server 130. For example, inventory manager 210 may store the supplemental content (e.g., image data, video data, etc.), either locally on server 130 or on content store 140 or another external storage location. In other examples, inventory manager 210 stores a link or other data that may be used to retrieve the supplemental content.

Inventory manager 210 may further store metadata describing the supplemental content, e.g., content type, file size, image size, duration (for video content), a content source or provider. Inventory manager 210 may further store data describing an intended audience for the supplemental content, relevant time frames for delivering the content (e.g., a particular date range, time of day, etc.), or other data related to distribution of the supplemental content.

Content placement manager 220 manages content delivery strategies, also referred to as campaigns, for supplemental content. For a given campaign, content placement manager 220 may receive and store input describing the content delivery strategy and implement the content delivery strategy according to the inputs. For example, content placement manager 220 may allow a content provider to set parameters such as targeting, scheduling, and budgets. While running the campaign, content placement manager 220 may implement one or more Kalman filters, use the Kalman filters to adjust one or more control knobs associated with a campaign, and run the campaign (e.g., set bid values) based on the control knobs. Content placement manager 220 is described in greater detail with respect to FIG. 3.

Bidding system 230 allows matching of supplemental content opportunities available through the content delivery platform (e.g., spaces for the various advertisements described above) to the supplemental content managed by content placement manager 220. Bidding system 230 may implement a programmatic ad exchange with an automated system for buying and selling of space for supplemental content. For example, bidding system 230 may implement a real-time bidding (RTB) system, in which ad space is bought and sold in real-time. Bidding system 230 may operate RTB in real-time, e.g., when a content delivery device 110 loads a page or app that is part of an ad exchange. In some cases, bidding system 230 or aspects of bidding system 230 may not operate in real-time, e.g., video advertisements delivered through streamed content may not be transacted in real-time. Programmatic ad exchanges, including RTB systems, may allow targeting of supplemental content to specific users based on demographics, behavior, and history on the content delivery platform, for example.

Reporting and analytics 240 captures and stores data describing delivery of supplemental content, and any response received to such content. For example, reporting and analytics 240 may track data describing impressions, including users or content delivery devices 110 to whom supplemental content was delivered. Reporting and analytics 240 may further store performance metrics such as clicks, conversions, revenue, fill rates, skip activity, etc. This activity is used by the content providers to assess performance, and also may be used by content placement manager 220 to adjust the content delivery strategy, as described further below.

Targeting system 250 allows supplemental content providers to reach specific audiences based on factors like geography, demographics, device type, behavior, and interests. Targeting system 250 may retrieve or maintain data describing users of the content delivery platform, which may be used by content placement manager 220 to target a campaign to a specific subset of users of the content delivery platform. Targeting system 250 may also enable supplemental content providers to customize their ad experiences, such as creating different ad formats or serving ads to particular user segments.

### Example Content Placement Manager for Managing Paced Delivery of Supplemental Content

FIG. 3 depicts a block diagram of content placement manager 220 of FIG. 2, according to some embodiments of the disclosure. Content placement manager 220 includes campaign inputs 310, observations 320, Kalman filters 330, performance control 340, pace control 350, and bid selector 360.

As noted above, content placement manager 220 may receive and store campaign inputs 310 describing a particular content delivery strategy (or campaign). Campaign inputs 310 may include, for example, a requested number of impressions and pricing information (e.g., a cost associated with a number of impressions, such as CPM, or an overall spend amount for the campaign). In some cases, rather than requesting a particular number of impressions at a particular rate, a supplemental content provider may pay according to a different objective, such as a target number of conversions, with the fee expressed as cost per acquisition (CPA) or cost per click (CPC). Still other arrangements may be used. Additional campaign inputs 310 may include targeting criteria as discussed above, scheduling information, or any other inputs described herein.

As a particular content delivery strategy is implemented, content placement manager 220 collects and stores observations 320 of the content delivery strategy. Observations 320 may include data describing RTB or other auctions in which the campaign participated (e.g., placed a bid) and the output of the auctions, e.g., for a given auction, whether the campaign delivered its associated supplemental content, or whether another campaign won the auction and delivered the supplemental content. Observations 320 may further include, for each auction, a bid value of the winning bid and how the campaign's bid value compared to the winning bid. For bids won by the campaign, observations 320 may further include any post-delivery user activity, e.g., clicks, conversions, etc. Some of this information may also or alternatively gathered by reporting and analytics 240, as described above.

Content placement manager 220 implements one or more Kalman filters 330 that use observations 320 to recommend adjustments to the content delivery strategy. Kalman filters 330 may be initialized at the beginning of the content delivery strategy. Kalman filters 330 may be updated throughout implementation of the content delivery strategy based on observations 320, and the content delivery strategy may be updated based on Kalman filters 330. For example, a first Kalman filter may be used to control a first knob related to performance of the campaign (e.g., reach, conversion, ROI, engagement, margin, etc.), and a second Kalman filter may be used to control a second knob related to pace of the campaign (e.g., a speed at which the campaign is delivering impressions, clicks, or conversions).

For example, the content delivery strategy, and in particular, a bid price for the content delivery strategy, may be determined based on a combination of variables, or values, related to performance and pace. In such embodiments, performance control 340 adjusts a first value related to performance based on an input from the first Kalman filter, and pace control 350 adjusts a second value related to pace based on an input from the second Kalman filter. Bid selector 360 calculates a bid value based on the first value and the second value.

More specifically, the first Kalman filter may calculate a first adjustment to a first control knob that is related to performance, and the second Kalman filter may calculate a second adjustment to a second control knob that is related to pace. Performance control 340 determines the first value (e.g., a first input value used to calculate the bid value) based on the first adjustment. Performance control 340 may apply the first adjustment to the first value to a previous setting for the first value. Performance control 340 may compare the adjusted first value to one or more boundary conditions for the first value, and may apply the first adjustment to the first value only if the boundary conditions are met with the adjustment to the first value.

In a similar manner, pace control 350 determines the second value (e.g., a second input value used to calculate the bid value) based on the second adjustment. Pace control 350 may apply the second adjustment to the second value to a previous setting for the second value. In some embodiments, pace control 350 determines the second value based on the second adjustment along with a decoupling value that at least partially decouples the effect of pacing from the performance. Pace control 350 may compare the adjusted second value to one or more boundary conditions for the second value, and pace control 350 may apply the second adjustment to the second value only if the boundary conditions are met with the adjustment to the second value.

Bid selector 360 calculates a setting for the content delivery strategy (e.g., a bid price for an auction) based on the first value and the second value, after performance control 340 and pace control 350 have adjusted one or both values. Content placement manager 220 then delivers content based on the setting for the content delivery strategy. For example, content placement manager 220 participates in bidding system 230 using the bid price determined by bid selector 360. In response to winning an auction in the bidding system 230, server 130 delivers supplemental content associated with the content delivery strategy to a content delivery device 110. In some embodiments, bid selector 360 may use additional factors (e.g., in addition to performance control 340 and pace control 350) in determining a bid value. For example, bid selector 360 may further base a bid value based on targeting criteria, e.g., with higher-value target audiences (e.g., users with particular demographic criteria) associated with higher bid values.

The objectives of the Kalman filters 330 described herein are merely examples, and in other embodiments, Kalman filters may be used to set control knobs related to different objectives. Furthermore, while the disclosure generally discusses two control knobs (e.g., performance control 340 and pace control 350), it should be understood that in other embodiments, content placement manager 220 may have three or more Kalman filters and three or more control knobs. While in the examples described herein, each Kalman filter controls a respective control knob, in some embodiments, more than one Kalman filter is used to control a single knob. For example, two Kalman filters are used to control one control knob, and a third Kalman filter is used to control a second control knob. Other combinations of Kalman filters and control knobs may be used. In such embodiments where multiple Kalman filters are used to control one control knob, a reconciliation step may be used to establish priority among competing or incompatible constraints.

Several example processes that may be performed by content placement manager 220 are described below, in relation to FIGS. 4-7.

While the content placement manager 220 is illustrated as one system within server 130, it should be understood that in various embodiments, various components within content placement manager 220 may be located within different devices, e.g., at different locations, or within different systems. For example, one or more memory systems may store observations 320; the calculations for Kalman filters 330, performance control 340, and pace control 350 may be performed on a different processing system; internal variables for the Kalman filters 330 or controllers 340 and 350 may be stored on a separate memory device, etc.

### Exemplary Processes for Implementing a Content Delivery Strategy

FIGS. 4-7 depict flow diagrams illustrating process performed by server 130 to implement content delivery strategies.

FIG. 4 depicts a flow diagram illustrating exemplary operations for conducting a placement campaign, according to some embodiments of the disclosure. The operations may be performed by components of server 130.

In 410, server 130 (e.g., content placement manager 220) initializes content placement settings. For example, content placement manager 220 may set initial values for Kalman filters 330. Content placement manager 220 may also set an initial bid value for bid selector 360, or initial bid criteria or bid value guidelines (e.g., if content placement manager 220 sets different bid values based on targeting criteria as described above).

In 420, Kalman filters 330 predict content placement behavior. For example, at the beginning of the campaign, content placement manager 220 may initialize one or more regression coefficients and a covariance matrix for each of the Kalman filters 330. After the campaign has run for at least one time-step and collected a measurement, Kalman filters 330 perform a state prediction, where they predict a next state of the system based on an estimate of the previous state and system dynamics (e.g., a state transition matrix, a control input matrix). Kalman filters 330 further predict an error covariance representing the uncertainty of the state estimate, based on a previous error covariance and process noise.

In 430, content placement manager 220 conducts and observes a content placement campaign. For example, the content placement manager 220 participates in the bidding system 230 to distribute the supplemental content for a set amount of time, e.g., 5 minutes, 20 minutes, 1 hour, 2 hours, or another length of time. Alternatively, content placement manager 220 may participate in the bidding system 230 for a certain number of impressions, a certain spend amount, etc. In the context of the Kalman filters, the set amount of time, number of impressions, spend amount, etc. is referred to as a time-step; after each time-step, the Kalman filters 330 are updated. During a time-step, content placement manager 220 collects observations 320 of the campaign's activity in bidding system 230, as described above.

In 440, content placement manager 220 determines whether the campaign is complete, e.g., whether the campaign has hit a particular target, such as an amount of money spent on impressions, a number of impressions, a number of conversions, etc. If the campaign is complete, at 460, content placement manager 220 reports a content placement summary to the supplemental content provider, e.g., based on information gathered by reporting and analytics 240.

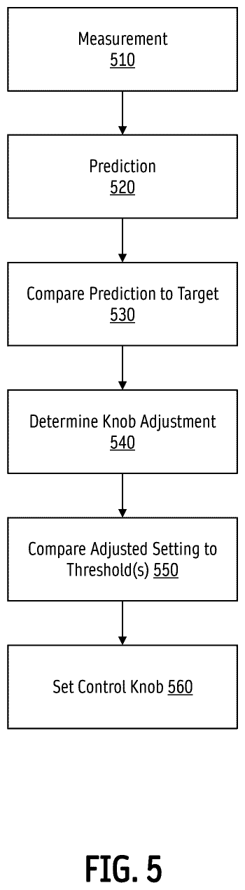

If the campaign is not complete, at 450, content placement manager 220 adjusts content placement settings. As described with respect to FIG. 3, Kalman filters 330 may determine adjustments to control knobs for their associated objectives, e.g., a performance objective and a pace objective. For example, Kalman filters 330 calculate an estimate for their respective control objective (e.g., a performance objective and pacing), and then use a state estimate to predict a change to a respective control knob that will bring the control objective within a desired range for that objective. Based on the control knob adjustments from Kalman filters 330, performance control 340 and pace control 350 may in turn adjust values input to bid selector 360, which provides an updated price setting for the content delivery strategy, as described with respect to FIG. 3, and further described with respect to FIG. 5.

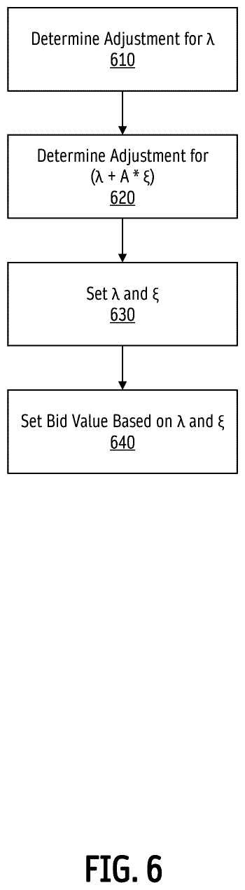

FIG. 5 depicts a flow diagram illustrating exemplary operations for setting a control knob for the content placement campaign, according to some embodiment of the disclosure. The operations may be performed by components in server 130, e.g., by content placement manager 220. FIG. 5 depicts an operation for a single control knob tied to one of the Kalman filters 330; this control knob and/or Kalman filter is associated with a particular objective. Content placement manager 220 may include multiple control knobs (e.g., two control knobs), each associated with a Kalman filter, and each associated with a different objective. As described with respect to FIG. 6, in setting control knobs in a multi-knob system, content placement manager 220 may perform a mathematical decoupling of the knobs.

At 510, content placement manager 220 performs measurement of the content delivery strategy, e.g., content placement manager 220 collects observations 320. Observations 320 describe one or more campaign objectives, e.g., pace and/or any of the performance objectives described above.

At 520, content placement manager 220 performs a prediction step for the content delivery strategy. For example, a Kalman filter 330 predicts content placement behavior based on the observations. The Kalman filter 330 may perform a state prediction, where the Kalman filter predicts a next state of the system based on an estimate of the previous state and system dynamics (e.g., a state transition matrix, a control input matrix). The Kalman filter 330 may further predict an error covariance representing the uncertainty of the state estimate, based on a previous error covariance and process noise.

At 530, content placement manager 220 compares the prediction from the previous step to a target for each of the objectives. For example, for a first Kalman filter related to performance, the Kalman filter compares a prediction related to performance to a target range for the performance. For a second Kalman filter related to pace, the Kalman filter compares a prediction related to pace to a target range for the pace.

At 540, content placement manager 220 determines a knob adjustment based on the prediction and the comparison. This enables the Kalman filter 330 to take into account prior campaign activity. For example, for the pace Kalman filter, if the campaign had previously over-delivered the supplemental content (e.g., the pace was too high), the knob adjustment may lower the pace so that the overall campaign pace falls within a desired range.

At 550, content placement manager 220 compares an adjusted setting based on the knob to one or more thresholds for the objective value. For example, performance control 340 may have an upper bound or a lower bound on a value related performance that is used by bid selector 360 to set the bid value. Performance control 340 may obtain a knob setting or knob adjustment for the performance value from Kalman filters 330, and performance control 340 determines whether to use the adjusted value for the performance value based on the comparison. At 560, content placement manager 220 sets the control knob based on the comparison.

For example, performance control 340 may have an upper bound of 5 for a performance control knob value; if the previous setting is 4 and the knob adjustment is 0.5, performance control 340 sets the performance control knob value to 4.5. If instead, the performance control knob value is already 5, performance control 340 maintains the performance control knob value of 5, even if Kalman filters 330 recommends an additional 0.5 adjustment to the performance control knob value.

FIG. 6 depicts a flow diagram illustrating exemplary operations for selecting a bid value based on two control knobs, according to some embodiments of the disclosure. FIG. 6 uses the values λ and ξ that are related to the two control knobs described above. Each of the values λ and ξ is related to a different objective for the campaign, e.g., λ is related to the performance objective, and ξ is related to the pace objective.

At 610, content placement manager 220 determines an adjustment for λ. For example, λₜ₋₁ is a prior value of λ at an earlier time-step t−1. The first Kalman filter may compare a predicted performance outcome based on the value of λₜ₋₁ to an actual outcome during the prior time-step, and estimate a change in λ to correct the performance outcome. The first Kalman filter thus determines an adjustment to λ, i.e., an adjustment to the first knob related to performance.

More specifically, the first Kalman filter uses a previous state estimate to predict the measurement and then compares the prediction to the actual measurement. The first Kalman uses this information to adjust a state estimate and a covariance matrix. The Kalman filter further uses the new state estimate to predict a long-run outcome (based on the current knob setting) and compares the predicted outcome to the target for the first knob (e.g., a target performance value). Then, the first Kalman filter adjusts the control knob and updates its estimates. In one implementation, the state transition matrix is an identity matrix, so a projection for the next time-step is an adjustment to the covariance estimate.

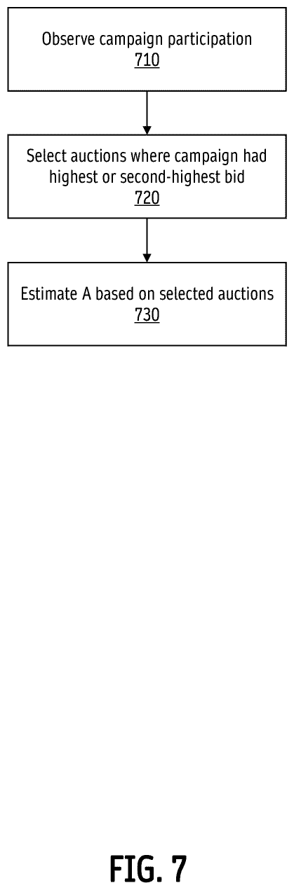

At 620, content placement manager 220 determines an adjustment for a second knob that is related to pace. The value ξ may be a pacing value used to calculate the bid value, but the second Kalman filter may not control ξ directly, but instead controls a value related to ξ. This is because the two Kalman filters may be coupled (e.g., the Kalman filters do not control pace and performance separately), and the value ξ is at least partially decoupled from the performance objective. The second Kalman filter may instead control a knob k₂ that may have a value expressed as k₂=(λ+A*ξ) , where A is a decoupling value. The decoupling value A may be determined based on a subset of the observed auctions, as described with respect to FIG. 7. The second Kalman filter may determine an adjustment to k₂, i.e., an adjustment to the second knob related to pace. Updating the second Kalman filter may be similar to the process for updating the first Kalman filter, described above. Following this process to determine k₂, ξ is calculated from k₂.

At 630, content placement manager 220 sets ξ and ξ based on the knob adjustments. Performance control 340 compares the adjusted value of λ to one or more boundary conditions and sets the value of λ based on whether the adjusted value is within the boundary condition(s), as described with respect to FIG. 5. Pace control 350 may compare the adjusted value of k₂ to one or more boundary conditions and sets the value of k₂ based on whether the adjusted value is within the boundary condition(s). Alternatively, pace control 350 may first calculate an adjusted value for ξ based on the adjusted value of k₂; pace control 350 then compares the adjusted value of ξ to the boundary conditions and sets the value of ξ based on whether the adjusted value is within the boundary conditions.

To calculate ξ from k₂, pace control 350 can compute ξ=(k₂−λ)/A, where k₂ is an adjusted value of the second knob, λ is the adjusted value of the first knob, A is the decoupling value, as described above and in relation to FIG. 7.

At 640, content placement manager 220 determines a setting for the content delivery setting, e.g., a bid value or bid price for the campaign, based on the settings for λ and ξ determined at 630. For example, bid selector 360 calculates a bid price as (ξ+λ*(x/x_{ref})*P, where x is an objective value, x_{ref} is a normalizing value for the objective, and P is a campaign pricing value. For example, P may be a CPM value, CPA value, or another pricing value for the campaign. The objective value x is related to an objective for the campaign. For example, for a conversion objective, x is a probability of incremental attribution. As another example, for a reach objective, x is the reach impact value. The normalizing value x_{ref} is used to scale the λ term relative to the ξ term in the bid value formula. In some cases, the normalizing value x_{ref} is not used, i.e., x_{ref}=1.

In some embodiments, if pace control 350 sets the adjusted value for k₂ based on a boundary condition for k₂, bid selector 360 may directly calculate the bid value setting directly from the two knob values λ and k₂, rather than calculating the intermediate value ξ.

Different processes illustrated in FIG. 6 may take place at different times, e.g., bid values may be set at 640 based on knob adjustments determined at 610 and 620 several minutes prior.

FIG. 7 depicts a flow diagram illustrating exemplary operations for calculating a decoupling value for the control knobs, according to some embodiments of the disclosure. The decoupling value A is used to decouple the pace control value ξ from the performance value λ, as described in relation to FIG. 6.

At 710, content placement manager 220 observes participation of the campaign in the bidding system 230, e.g., to collect observations 320. The content placement manager 220 may collect observations over the course of multiple campaigns, e.g., multiple related campaigns, and use these observations to set A for future campaigns.

At 720, content placement manager 220 selects, from the observations, a subset of auctions in which the campaign had the highest bid (e.g., the campaign won the auction and delivered supplemental content), and auctions in which the campaign had the second-highest bid, and a different campaign won the auction.

At 730, content placement manager 220 calculates the decoupling value A based on the selected subset of auctions. For example, content placement manager 220 estimates A by determining a simultaneous change in λ and ξ that would keep the same average bid value across this subset of auctions. This value A is presumed to be pacing-neutral, and therefore, can decouple the values of ξ and λ.

### Example Computing Device

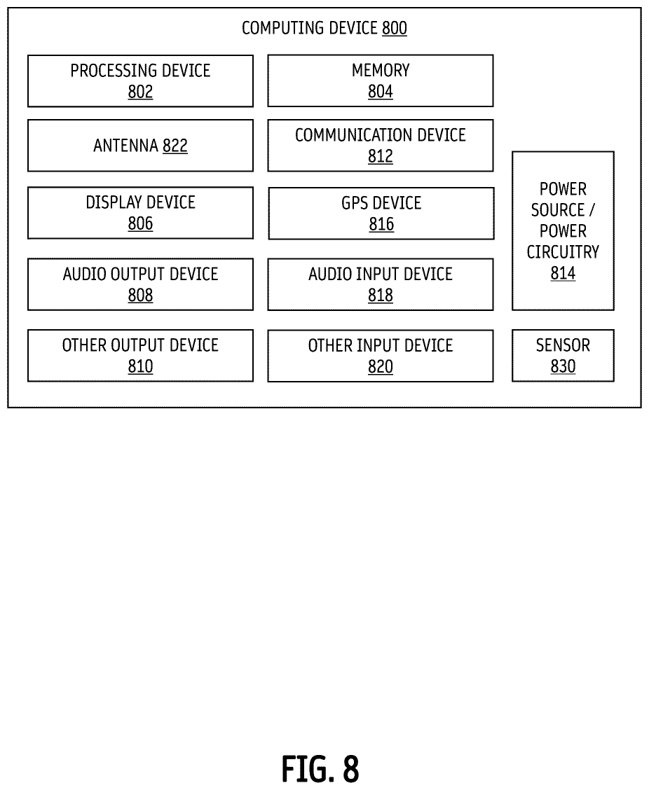

FIG. 8 depicts a block diagram of an exemplary computing device 800, according to some embodiments of the disclosure. One or more computing devices, such as computing device 800, may be used to implement the functionalities described with reference to the FIGS. and herein. A number of components are illustrated in the FIGS. as included in computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, and the computing device 800 may include interface circuitry for coupling to the one or more components. For example, the computing device 800 may not include a display device 806, and may include display device interface circuitry (e.g., a connector and driver circuitry) to which a display device 806 may be coupled. In another set of examples, the computing device 800 may not include an audio input device 818 or an audio output device 808 and may include audio input or output device interface circuitry (e.g., connectors and supporting circuitry) to which an audio input device 818 or audio output device 808 may be coupled.

The computing device 800 may include a processing device 802 (e.g., one or more processing devices, one or more of the same type of processing device, one or more of different types of processing device). The processing device 802 may include electronic circuitry that process electronic data from data storage elements (e.g., registers, memory, resistors, capacitors, quantum bit cells) to transform that electronic data into other electronic data that may be stored in registers and/or memory. Examples of processing device 802 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 800 may include a memory 804, which may itself include one or more memory devices such as volatile memory (e.g., DRAM), non-volatile memory (e.g., read-only memory (ROM)), high bandwidth memory (HBM), flash memory, solid state memory, and/or a hard drive. Memory 804 includes one or more non-transitory computer-readable storage media. In some embodiments, memory 804 may include memory that shares a die with the processing device 802. In some embodiments, memory 804 includes one or more non-transitory computer-readable media storing instructions executable to perform operations described with the FIGS, e.g., with respect to the content placement manager 220. The instructions stored in the one or more non-transitory computer-readable media may be executed by processing device 802. In some embodiments, memory 804 may store data, e.g., data structures, binary data, bits, metadata, files, blobs, etc., as described with the FIGS. and herein.

In some embodiments, the computing device 800 may include a communication device 812 (e.g., one or more communication devices). For example, communication device 812 may be configured for managing wired and/or wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP 2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 812 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 812 may operate in accordance with other wireless protocols in other embodiments. The computing device 800 may include an antenna 822 to facilitate wireless communications and/or to receive other wireless communications (such as radio frequency transmissions). The computing device 800 may include receiver circuits and/or transmitter circuits. In some embodiments, the communication device 812 may manage wired communications, such as electrical, optical, or any other suitable communication protocols (e.g., the Ethernet). As noted above, communication device 812 may include multiple communication chips. For instance, a first communication device 812 may be dedicated to shorter-range wireless communications such as Wi-Fi or Bluetooth, and a second communication device 812 may be dedicated to longer-range wireless communications such as global positioning system (GPS), EDGE, GPRS, CDMA, WiMAX, LTE, EV-DO, or others. In some embodiments, a first communication device 812 may be dedicated to wireless communications, and a second communication device 812 may be dedicated to wired communications.

The computing device 800 may include power source/power circuitry 814. The power source/power circuitry 814 may include one or more energy storage devices (e.g., batteries or capacitors) and/or circuitry for coupling components of the computing device 800 to an energy source separate from the computing device 800 (e.g., DC power, AC power, etc.).

The computing device 800 may include a display device 806 (or corresponding interface circuitry, as discussed above). Display device 806 may include any visual indicators, such as a heads-up display, a computer monitor, a projector, a touchscreen display, a liquid crystal display (LCD), a light-emitting diode display, or a flat panel display, for example.

The computing device 800 may include an audio output device 808 (or corresponding interface circuitry, as discussed above). The audio output device 808 may include any device that generates an audible indicator, such as speakers, headsets, or earbuds, for example.

The computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

The computing device 800 may include a GPS device 816 (or corresponding interface circuitry, as discussed above). The GPS device 816 may be in communication with a satellite-based system and may receive a location of the computing device 800, as known in the art.

The computing device 800 may include a sensor 830 (or one or more sensors). The computing device 800 may include corresponding interface circuitry, as discussed above). Sensor 830 may sense physical phenomenon and translate the physical phenomenon into electrical signals that can be processed by, e.g., processing device 802. Examples of sensor 830 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 800 may include another output device 810 (or corresponding interface circuitry, as discussed above). Examples of the other output device 810 may include an audio codec, a video codec, a printer, a wired or wireless transmitter for providing information to other devices, haptic output device, gas output device, vibrational output device, lighting output device, home automation controller, or an additional storage device.

The computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 800 may have any desired form factor, such as a handheld or mobile computer system (e.g., a cell phone, a smart phone, a mobile Internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 800 may be any other electronic device that processes data.

### Select Examples

Example 1 provides a method including setting a first value for a first control knob and a second value for a second control knob; retrieving an observation of a content delivery strategy; calculating a first adjustment to the first control knob based on the observation; calculating a second adjustment to the second control knob based on the observation and the first adjustment to the first control knob; adjusting at least one of the first value and the second value based on the first adjustment or the second adjustment; calculating a setting for the content delivery strategy based on the first value and the second value; and delivering content to a user based on the setting for the content delivery strategy.

Example 2 provides the method of example 1, where the first control knob is related to reach of the content.

Example 3 provides the method of example 1, where the first control knob is related to an action taken by a user in response to the content.

Example 4 provides the method of example 1, where the second control knob is related to pace of delivery of the content.

Example 5 provides the method of example 1, where adjusting the first value based on the first adjustment includes calculating a third value of the first control knob based on the first adjustment and the first value; comparing the third value of the first control knob to a boundary condition for the first control knob; and setting the first control knob to the third value in response to determining that the third value is within the boundary condition.

Example 6 provides the method of example 1, where adjusting the first value based on the first adjustment includes calculating a third value of the first control knob based on the first adjustment and the first value; comparing the third value of the first control knob to a boundary condition for the first control knob; and setting the first control knob to the first value in response to determining that the third value is outside of the boundary condition.

Example 7 provides the method of example 1, where calculating the setting for the content delivery strategy further includes calculating a pacing value based on the second value for the second control knob and the second adjustment.

Example 8 provides the method of example 7, where the pacing value is further calculated based on a decoupling value that at least partially decouples the first control knob from the second control knob.

Example 9 provides the method of example 8, where the pacing value ξ is calculated as ξ=(k₂−2)/A, where k₂ is an adjusted value of the second control knob, λ is an adjusted value of the first control knob, and A is a decoupling value.

Example 10 provides the method of example 9, where the setting for the content delivery strategy is a bid price that is calculated as (ξ+λ*(x/x_{ref})*P, where x is an objective value, x_{ref} is a normalizing value for the objective value, and P is a campaign pricing value.

Example 11 provides the method of example 1, further including calculating a third adjustment to a third control knob; and calculating the setting for the content delivery strategy further based on the third control knob.

Example 12 provides a system including at least one memory; and at least one processing component coupled to the at least one memory, the at least one processing component to: set a first value for a first control knob and a second value for a second control knob; retrieve an observation of a content delivery strategy; calculate a first adjustment to the first control knob based on the observation; calculate a second adjustment to the second control knob based on the observation and the first adjustment to the first control knob; adjust at least one of the first value and the second value based on the first adjustment or the second adjustment; calculate a setting for the content delivery strategy based on the first value and the second value; and deliver content to a user based on the setting for the content delivery strategy.

Example 13 provides the system of example 12, where the first control knob is related to reach of the content or to an action taken by a user in response to the content.

Example 14 provides the system of example 12, where the second control knob is related to pace of delivery of the content.

Example 15 provides the system of example 12, where adjusting at least one of the first value and the second value based on the first adjustment or the second adjustment includes calculating a third value of the first control knob based on the first adjustment and the first value; comparing the third value of the first control knob to a boundary condition for the first control knob; and setting the first control knob to the third value in response to determining that the third value is within the boundary condition, or setting the first control knob to the first value in response to determining that the third value is outside of the boundary condition.

Example 16 provides the system of example 12, where calculating the setting for the content delivery strategy further includes calculating a pacing value based on the second value for the second control knob, the second adjustment, and a decoupling value that at least partially decouples the first control knob from the second control knob.

Example 17 provides one or more non-transitory computer-readable media storing instructions that, when executed by one or more processors, cause the one or more processors to: set first value for a first control knob and a second value for a second control knob; retrieve an observation of a content delivery strategy; calculate a first adjustment to the first control knob based on the observation; calculate a second adjustment to the second control knob based on the observation and the first adjustment to the first control knob; adjust at least one of the first value and the second value based on the first adjustment or the second adjustment; calculate a setting for the content delivery strategy based on the first value and the second value; and deliver content to a user based on the setting for the content delivery strategy.

Example 18 provides the computer-readable media of example 17, where the first control knob is related to reach of the content or to an action taken by a user in response to the content.

Example 19 provides the computer-readable media of example 17, where the second control knob is related to pace of delivery of the content.

Example 20 provides the computer-readable media of example 17, where adjusting at least one of the first value and the second value based on the first adjustment or the second adjustment includes calculating a third value of the first control knob based on the first adjustment and the first value; comparing the third value of the first control knob to a boundary condition for the first control knob; and setting the first control knob to the third value in response to determining that the third value is within the boundary condition, or setting the first control knob to the first value in response to determining that the third value is outside of the boundary condition.

Example A provides one or more non-transitory computer-readable media storing instructions that, when executed by one or more processors, cause the one or more processors to perform any one of the methods described herein.

Example B provides an apparatus comprising means to carry out or means for carrying out any one of the methods provided in examples 1-20, and/or any one of the methods described herein.

Example C provides a computer-implemented system, comprising one or more processors, and one or more non-transitory computer-readable media storing instructions that, when executed by the one or more processors, cause the one or more processors to perform any one of the methods provided in examples 1-20 and/or any one of the methods described herein.

Example D provides a computer-implemented system comprising one or more components illustrated in FIG. 1 to perform operations described herein.

Example E provides a computing device comprising one or more components illustrated in FIG. 8 to perform operations described herein.

### Variations and Other Notes

The description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the above detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method comprising:
setting a first value for a first control knob and a second value for a second control knob, wherein the first value represents a first objective of a content delivery strategy and the second value represents a second objective of the content delivery strategy, the second objective affected by the first objective;
retrieving a plurality of observations of the content delivery strategy;
calculating a first adjustment to the first control knob based on at least one observation of the plurality of observations;
calculating a second adjustment to the second control knob based on the at least one observation;
determining a decoupling value that at least partially decouples the first control knob from the second control knob based on a subset of the plurality of observations of content delivery strategy;
adjusting the first value based on the first adjustment and adjusting the second value based on the first adjustment, the second adjustment, and the decoupling value;
calculating a setting for the content delivery strategy based on the first value and the second value; and
delivering content based on the setting for the content delivery strategy.

2. The method of claim 1, wherein the first control knob is related to reach of the content.

3. The method of claim 1, wherein the first control knob is related to an action taken by a user in response to the content.

4. The method of claim 1, wherein the second control knob is related to pace of delivery of the content.

5. The method of claim 1, wherein adjusting the first value based on the first adjustment comprises:
calculating a third value of the first control knob based on the first adjustment and the first value;
comparing the third value of the first control knob to a boundary condition for the first control knob; and
setting the first control knob to the third value in response to determining that the third value is within the boundary condition.

6. The method of claim 1, wherein adjusting the first value based on the first adjustment comprises:
calculating a third value of the first control knob based on the first adjustment and the first value;
comparing the third value of the first control knob to a boundary condition for the first control knob; and
setting the first control knob to the first value in response to determining that the third value is outside of the boundary condition.

7. The method of claim 1, wherein adjusting the second value further comprises calculating a pacing value based on the first adjustment, the second adjustment, and the decoupling value. value based on the second

8. (canceled)

9. The method of claim 7, wherein the pacing value ξ is calculated as ξ=(k₂−λ)/A, wherein k₂ is an adjusted value of the second control knob, λ is an adjusted value of the first control knob, and A is the decoupling value.

10. The method of claim 9, wherein the setting for the content delivery strategy is a bid price that is calculated as (ξ+λ*(x/x_{ref}))*P, where x is an objective value, x_{ref} is a normalizing value for the objective value, and P is a campaign pricing value.

11. (canceled)

12. A system comprising:
at least one memory; and
at least one processing component coupled to the at least one memory, the at least one processing component to:
set a first value for a first control knob and a second value for a second control knob, wherein the first value represents a first objective of a content delivery strategy and the second value represents a second objective of the content delivery strategy, the second objective affected by the first objective;
retrieve a plurality of observations of the content delivery strategy;
calculate a first adjustment to the first control knob based on at least one observation of the plurality of observations;
calculate a second adjustment to the second control knob based on the at least one observation;
determine a decoupling value that at least partially decouples the first control knob from the second control knob based on a subset of the plurality of observations of content delivery strategy;
adjust the first value based on the first adjustment and adjust the second value based on the first adjustment, the second adjustment, and the decoupling value;
calculate a setting for the content delivery strategy based on the first value and the second value; and
deliver content based on the setting for the content delivery strategy.

13. The system of claim 12, wherein the first control knob is related to reach of the content or to an action taken by a user in response to the content.

14. The system of claim 12, wherein the second control knob is related to pace of delivery of the content.

15. The system of claim 12, wherein adjusting the first value based on the first adjustment:
calculating a third value of the first control knob based on the first adjustment and the first value;
comparing the third value of the first control knob to a boundary condition for the first control knob; and
setting the first control knob to the third value in response to determining that the third value is within the boundary condition, or setting the first control knob to the first value in response to determining that the third value is outside of the boundary condition.

16. The system of claim 12, wherein adjusting the second value further comprises calculating a pacing value based on the first adjustment, the second adjustment, and the decoupling value.

17. One or more non-transitory computer-readable media storing instructions that, when executed by one or more processors, cause the one or more processors to:
set first value for a first control knob and a second value for a second control knob, wherein the first value represents a first objective of a control delivery strategy and the second value represents a second objective of the content delivery strategy, the second objective affected by the first objective;
retrieve a plurality of observations of the content delivery strategy;
calculate a first adjustment to the first control knob based on at least one observation of the plurality of observations;
calculate a second adjustment to the second control knob based on the at least one observation;
determine a decoupling value that at least partially decouples the first control knob from the second control knob based on a subset of the plurality of observations of content delivery strategy;
adjust the first value based on the first adjustment and adjust the second value based on the first adjustment, the second adjustment, and the decoupling value;
calculate a setting for the content delivery strategy based on the first value and the second value; and
deliver content to a user based on the setting for the content delivery strategy.

18. The computer-readable media of claim 17, wherein the first control knob is related to reach of the content or to an action taken by a user in response to the content.

19. The computer-readable media of claim 17, wherein the second control knob is related to pace of delivery of the content.

20. The computer-readable media of claim 17, wherein adjusting the first value based on the first adjustment:
calculating a third value of the first control knob based on the first adjustment and the first value;
comparing the third value of the first control knob to a boundary condition for the first control knob; and
setting the first control knob to the third value in response to determining that the third value is within the boundary condition, or setting the first control knob to the first value in response to determining that the third value is outside of the boundary condition.

21. The method of claim 1, wherein each observation in the subset corresponds to an auction in which a bid associated with the content delivery strategy was a highest bid or a second-highest bid.

22. The system of claim 12, wherein each observation in the subset corresponds to an auction in which a bid associated with the content delivery strategy was a highest bid or a second-highest bid.
